(19) United States
(12) Patent Application Publication
(10) Pub. No.: US 2024/0011349 A1
(43) Pub. Date: Jan. 11, 2024

(54) REVOLVING DOOR AND METHOD FOR ASSEMBLING A REVOLVING DOOR

(71) Applicant: dormakaba Deutschland GmbH, Ennepetal (DE)

(72) Inventors: Tim Wulbrandt, Ennepetal (DE); Daniel Fabri, Ennepetal (DE); Thomas Irrgang, Ennepetal (DE); Bernhard Heitz, Ennepetal (DE); Thomas Uebelgünne, Ennepetal (DE)

(21) Appl. No.: 18/345,457

(22) Filed: Jun. 30, 2023

(30) Foreign Application Priority Data
Jul. 11, 2022 (EP) 22184163.8

(51) Int. Cl. E06B 3/90

(52) U.S. Cl. CPC E06B 3/90

(57) ABSTRACT

A revolving door with a turnstile which is arranged between opposing barrel elements and with a ceiling assembly which is arranged on top of the barrel elements and on which the turnstile is rotatably mounted. The ceiling assembly has a sandwich design with at least one bottom cover panel and/or at least one top cover panel and at least one filler.

### CROSS-REFERENCE TO RELATED APPLICATIONS

This application claims the benefit of European patent application 22184163.8 filed 11 Jul. 2022, the disclosure of which is incorporated herein by reference in its entirety.

### TECHNICAL FIELD

The disclosure relates to a revolving door with a turnstile which is arranged between opposing barrel elements and with a ceiling assembly which is arranged on top of the barrel elements and on which the turnstile is rotatably mounted. Furthermore, the disclosure relates to a method for producing a ceiling assembly for a revolving door.

### BACKGROUND

EP 1 605 128 B1 discloses an example of a revolving door with a turnstile which is arranged between opposing barrel elements and with a ceiling assembly which is arranged on top of the barrel elements and on which the turnstile is rotatably mounted. In this respect, the revolving door comprises two opposing barrel elements with a turnstile arranged therebetween, and the ceiling assembly is located on top of the turnstile and merges physically and structurally with the barrel elements. The ceiling assembly is shown as forming a supporting structure with the barrel elements, and the ceiling assembly has a connecting element arranged in the center of the revolving door, and supports extending radially therefrom are provided, and within the barrel walls and beneath the ceiling assembly is arranged the turnstile suspended from the ceiling assembly, with the supports extending from the center to the barrel walls being held under pretension to create an upward force on the connecting element.

The complex design of the ceiling assembly in connection with the barrel elements makes it clear that the revolving door with the individual parts of the ceiling assembly can only be assembled on-site, in particular with integration into a wall or into a glass facade of a building. The assembly of such a revolving door is complex and the individual components of the ceiling assembly must be adjusted to the dimensions on-site such that the effort involved in assembling the revolving door is also considerably increased.

Another exemplary embodiment of a revolving door is known from EP 3 611 326 B1. Here, too, it can be seen that the design of the ceiling assembly is complex and must be assembled on-site in structural unity with the barrel elements. In particular, the ceiling assembly has a large number of individual parts that have to be connected to the barrel elements in a time-consuming manner.

### SUMMARY

The disclosure simplifies the assembly of a revolving door, in particular in connection with the ceiling assembly, which is to be provided in the simplest possible way and arranged on top of the elements and on which, lastly, the turnstile is accommodated in a rotatably mounted manner. In particular, the on-site assembly of the revolving door should be considerably simplified and the time required for this should be reduced by an improved ceiling assembly.

This is achieved by proceeding from a revolving door according to the preamble of the claim 1 and a method according to claim 11 each with the characterizing features. Advantageous further developments of the disclosure are indicated in the dependent claims.

To achieve these advantages, the disclosure provides that the ceiling assembly has a sandwich design with at least one bottom cover panel and/or at least one top cover panel and at least one filler.

The basic idea of the disclosure is to provide a modular ceiling assembly that has a sandwich design such that at least one filler is provided as the core material, and the filler has a cover panel on at least one cover surface or on both cover surfaces. In this respect, only one top cover panel, only one bottom cover panel or one top and one bottom cover panel can be provided, which preferably run parallel to one another and between which the filler is located. It is also conceivable that further cover panels are present, which penetrate the filler and, for example, form a cover panel intermediate level. An intermediate level may be necessary, for example, to increase the rigidity of the ceiling assembly and to accommodate components within the ceiling assembly or to hold them together or stiffen them together in their overall structure. The basic idea, however, is a sandwich design that enables a ceiling assembly that can be handled in a modular manner, which can be connected as a whole to the barrel elements on-site, in particular can be placed on top of the barrel elements, preferably with the turnstile being accommodated in a rotatable manner between the barrel elements. In particular, the terms bottom and top refer to the installed state of the revolving door.

It should be noted that only one of the barrel elements can have the design described in connection with the ceiling assembly.

Thus, the modular ceiling assembly preferably results in an assembly which can be handled individually and can be attached to the barrel elements and/or the turnstile and can be detached again, in particular reversibly, from the barrel elements and/or the turnstile. For example, the ceiling assembly can be prefabricated at the factory such that the ceiling assembly only has to be connected to the barrel elements and the turnstile at the destination, without the basic components of the ceiling assembly having to be assembled or joined on-site. This results in significantly shorter assembly times and the general design of the ceiling assembly is simplified. According to the idea of the disclosure, the ceiling assembly is, in this regard, designed as a module, which can be attached to the other components of the revolving door and which can be arranged on the barrel walls and the turnstile and can also be removed from the position of the arrangement again.

According to a further embodiment, the basic design of the ceiling assembly provides that one or a plurality of structural elements and/or functional elements of the revolving door are accommodated at least partially at or over, for example, above the bottom cover panel and/or at or over, for example, above the top cover panel, in particular in the region of the filler. It goes without saying that structural elements and/or functional elements can also protrude laterally, that is to say in particular projecting radially or from the cover panels at the top or bottom. In particular, the structural elements and/or functional elements can be surrounded by the filler or they are embedded in the filler. For example, a disc motor for driving the turnstile in a rotatable manner can be arranged on the bottom of the ceiling assembly such that it is for example partially integrated within the ceiling assembly and partially protrudes from it. Motors of this type are also referred to as torque or pancake motors and are usually connected to the turnstile without gears. The same applies, for example, to connecting elements for connecting the ceiling assembly to the barrel elements or to top structural elements of a building facade, which can also protrude out of the basic structure of the ceiling assembly in sections.

The structural elements can, for example, pass through the ceiling assembly diametrically and/or the structural elements can connect the top and the bottom cover panels to one another or be connected to just one cover panel. Although the filler is placed between the cover panels such that it surrounds the structural elements and/or the functional elements, the structural elements and/or the functional elements may also divide the filler into a plurality of partial elements, when the elements completely traverse the ceiling assembly, for example. With regard to the structural elements, it is conceivable, for example, to have a framework-like design, a star-shaped design or, for example, a rectangular or hexagonal design in order to correspondingly stiffen the ceiling assembly.

Furthermore, the bottom cover panel and/or the top cover panel has one or a plurality of openings such that one or a plurality of structural elements and/or functional elements can be arranged in connection with the openings. The optional openings in the top and/or bottom region of the ceiling assembly, but if necessary also in the lateral circumferential region, enable the integration of functional elements on-site. In particular, the one or plurality of openings can be designed as bores.

The one or plurality of functional elements preferably comprise a drive, a controller, a sensor device, a light device, a loudspeaker device, a power supply, a lock, a ventilation device, a heating element and/or the like, in particular with the functional elements being able to be introduced into one or a plurality of openings or into other recesses or intermediate regions in the filler. With integrated components of these types, the assembly work is simplified, in particular at the installation site. In particular, a heating element can thereby reduce a possible snow load on the revolving door.

Advantageously, the bottom cover panel and/or the top cover panel are connected to the filler in a materially-bonded and/or force-fitting and/or form-fitting manner. The at least one cover panel is preferably adhered, soldered and/or welded to the filler and/or optionally also to the structural elements and/or functional elements, with force-fitting or form-fitting connections also being possible, for example by pressing the cover panel onto corresponding counter-elements, in particular in or on the filler, on the structural elements and/or on the functional elements. It is also conceivable to connect together the two opposing cover panels arranged spaced apart from one another with connecting elements such that the sandwich composite is formed and the ceiling assembly is formed as a component that can be handled individually.

According to an additional and in particular preferred alternative variant, the bottom cover panel and/or the top cover panel can be connected to one another with the filler in a thermobonding process. It is thus possible that after assembling the ceiling assembly with the filler and the cover panels and optionally also with further functional and structural elements, the sandwich thus formed is thermally pressed in a furnace, i.e. thoroughly baked, in that by applying a pressing force while heating, the materially-bonded composite is generated, and in particular the parallelism of the cover panels and the exact height of the ceiling assembly can be calibrated at the same time.

The bottom cover panel and/or the top cover panel can be made of an aluminum material, a steel material and/or a plastic material, in particular a fiber-reinforced, preferably glass fiber-reinforced, plastic and/or a glass material and/or the filler can be a polyurethane material and/or have a honeycomb structure. Alternatively, the filler can also consist of cellulose, mineral wool and/or melamine, with a foamed filler also being possible. In particular, the filler can be foamed, for example based on a PU foam, between the cover panels and the functional elements and/or structural elements in the foaming process. As a result, a materially-bonded connection between the cover panels and the filler is already further advantageously produced in the foaming process, and it is also possible for the materially-bonded connection to be produced between the functional elements and/or structural elements. For example, a retaining device can be configured to hold the components of the ceiling assembly in position, and then the filler is introduced in the foaming process.

It is even conceivable here to provide the cover panels in a parallel belt system and to foam the filler such that at least the structure can be produced in a continuous process from the filler and the at least one, preferably both, cover panels, and structural and/or functional elements and other features can then be configured, such as openings, in at least one of the cover panels and the like by, for example, millings being provided in the raw sandwich body in order to introduce the structural and/or functional elements.

For example, the structural elements can penetrate the filler and/or it is provided that the filler is divided into at least two or a plurality of parts by the structural elements. In particular, when intermediate cover panels are configured, the filler can also be divided into a top filling level and a bottom filling level.

The ceiling assembly is particularly advantageously arranged on the barrel elements such that they laterally enclose the ceiling assembly and/or that the barrel elements extend up to the height of the top cover panel and/or that the barrel elements end in particular flush with the top cover panel. It is also thereby possible for the barrel elements to extend at least over part of the height of the ceiling assembly, with the connection between the barrel elements and the ceiling assembly being particularly advantageously based on a materially-bonded connection, in particular an adhesive connection.

A ceiling device is preferably arranged on the turnstile so that it rotates along with it. The ceiling device preferably covers the bottom of the ceiling assembly and/or the ceiling device has a diameter which corresponds substantially to the diameter of the ceiling assembly. Such a co-rotating ceiling device further improves the modular design of the individual assembly elements. In particular, the ceiling device can hide the potentially unsightly ceiling assembly and thus make it more appealing for the person entering. In this case, the turnstile can comprise leaf elements, with the ceiling device being able to have parts which are arranged at the top end of the turnstile pointing in the direction of the ceiling device between the leaf elements. The parts can be connected on or at the leaf elements in a force-fitting and/or materially-bonded and/or form-fitting manner, and it can be provided that the parts form a stiffening structure for the leaf elements and therefore also for the turnstile as a whole. The number of parts can thereby correspond to the number of leaf elements of the turnstile. There is thus the possibility that the parts, arranged on the leaf elements, form a structure which aligns the leaf elements with one another and/or forms a stiffening structure. The ceiling device particularly advantageously has at least one light means. It is also conceivable that the ceiling device has a sensor means, a monitoring means, a blocking means for blocking the rotary movement of the turnstile or, for example, a loudspeaker or scenting device.

Preferably, the barrel elements each have an inner glass element and an outer glass element, with the ceiling assembly resting directly or indirectly on a top finishing surface of the inner glass element and/or on a top finishing surface of the outer glass element. In this context, glass can be designed in different ways, in particular as plastic glass or the like. In particular, the inner glass element can have a shorter vertical length than the outer glass element, so that the outer glass element encloses the ceiling assembly on the outside at least partially or completely, in particular with regard to the height and/or with regard to the circumference of the ceiling assembly, when the ceiling assembly rests on the top finishing surface of the inner glass element and/or on the top finishing surface of the outer glass element. In particular, the ceiling assembly can thereby be connected, in particular adhered, to the barrel elements or preferably rest on a profile element, which in turn can be connected, in particular adhered, to the barrel elements. This results overall in a statically and/or visually advantageous design of the ceiling assembly in connection with the barrel elements, in particular with a reduction in the number of parts.

Furthermore, the disclosure relates to a method for assembling a ceiling assembly for a revolving door, in particular designed as described above, with the method comprising at least the following steps, in particular in the order listed: providing a bottom cover panel and/or providing a top cover panel; in particular configuring the structural elements and/or functional elements at or on the bottom cover panel and/or at or on the top cover panel; introducing a filler at the bottom cover panel and/or at the top cover panel and connecting, in particular in a materially-bonded and/or force-fitting and/or form-fitting manner, the bottom cover panel and/or the top cover panel to the filler. During the production of the ceiling assembly, the top cover panel can also first be configured on the bottom in order to configure the filler and/or the structural and/or functional elements. Within the meaning of the present disclosure, it makes no difference whether the ceiling assembly has only one bottom cover panel, only one top cover panel or a bottom and a top cover panel, since the top and bottom of the cover panels are only defined in the final installation position and the ceiling assembly, for example can also be removed resting on the subsequent top side.

It should be explicitly mentioned that features of the method can be transferred to the revolving door according to the disclosure and vice versa as according to the disclosure.

The filler can be configured in various ways on the at least one or between both cover panels. For example, the filler can be arranged in the geometrically prefabricated elements in the intermediate regions between the structural elements and/or functional elements. It is also conceivable that the filler is foamed and thus fills the intermediate spaces between the cover panels and/or the structural elements and functional elements and stiffens the structural and/or functional elements together or even holds them in position solely through the filler itself.

The materially-bonded connection of the bottom cover panel and/or the top cover panel to the filler can be produced using a thermobonding process, in particular by introducing heat and applying a corresponding pressing force. It is also possible to arrange a jacket body such as a circumferential metal sheet or a plastic strip on the circumference in order to close off the filler in the radial direction to the outside.

In particular, the method provides that the ceiling assembly is designed as an assembly which can be handled individually and is attached to the barrel elements and/or the turnstile, in particular in a reversibly detachable manner. Particularly advantageously, the ceiling assembly can also be detached from the barrel elements at any time. The ceiling assembly is substantially completely prefabricated at the factory and is brought to the destination of the revolving door as a finished assembly. This results in a significantly reduced assembly effort at the installation site of the revolving door.

### BRIEF DESCRIPTION OF THE DRAWINGS

Further measures that improve the disclosure will be outlined in greater detail below together with the description of a preferred exemplary embodiment of the disclosure on the basis of the figures, in which is shown:

FIG. 1 a view of a revolving door with a turnstile and the barrel element surrounding the turnstile, and with a top ceiling assembly,

FIG. 2-FIG. 4 the assembly of the ceiling assembly, represented in three steps,

FIG. 5 a cross-sectional view through the ceiling assembly,

FIG. 6 a view of the revolving door with isolated components, and

FIG. 7 a schematic representation of the process sequence for assembling such a ceiling assembly.

### DETAILED DESCRIPTION OF THE DRAWINGS

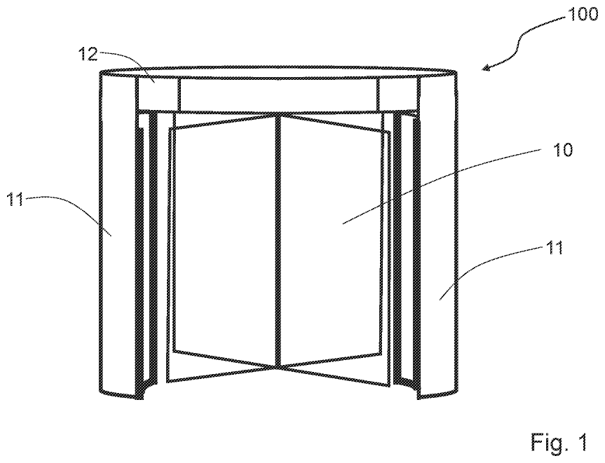

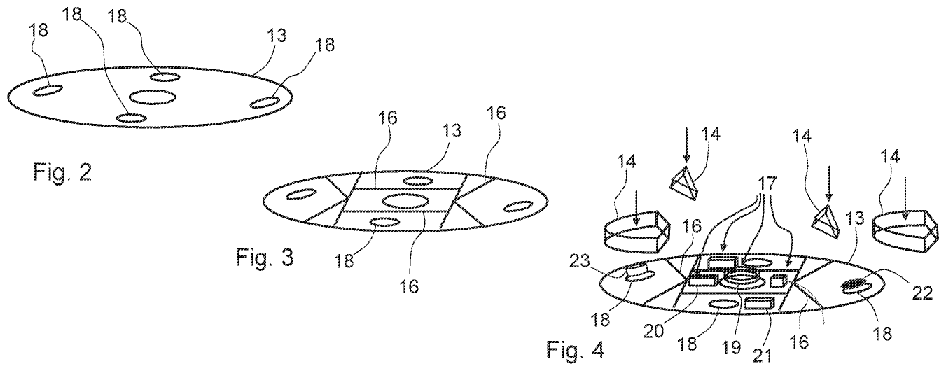

FIG. 1 shows in a perspective view a revolving door 100 with a turnstile 10 which is arranged between opposing barrel elements 11 and with a ceiling assembly which is arranged on top of the barrel elements 11 and on which the turnstile 10 is rotatably mounted. The ceiling assembly 12 has a sandwich design, which is explained in more detail with regard to its design and the steps for assembly with the following FIGS. 2, 3 and 4.

FIG. 2 shows an example of a bottom cover panel 13, which forms a circular disc and in this respect has a diameter which corresponds approximately to the diameter of the revolving door 100 or at least to the diameter on the inside of the barrel elements. A plurality of openings 18 are introduced into the bottom cover panel 13, into which openings functional elements such as loudspeakers, light devices, sensors, scenting devices and the like can later be inserted.

FIG. 3 shows the bottom cover panel 13 with the openings 18 and structural elements 16 which are applied to the cover panel 13 and which are, for example, designed like a framework and are located between the openings 18.

FIG. 4 shows the design of the bottom cover panel 13 with the openings 18 and the structural elements 16, with functional elements 17 also being configured, between which parts of the filler 14 are lastly inserted. The functional elements 17 thereby relate, for example, to a drive 19 for driving, in a rotary manner, the turnstile, a controller 20, a sensor device 21, a light device 22 or a loudspeaker device 23. The exemplary embodiment shows individual parts of the filler 14, with the filler 14 being shown as dimensionally stable parts which can alternatively also be foamed in between the structural elements 16 and the functional elements 17.

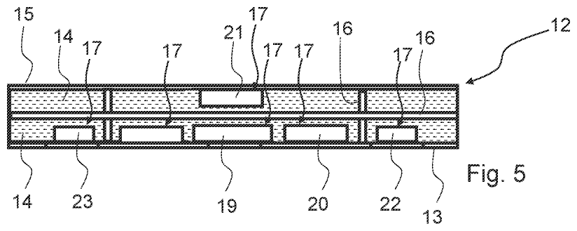

In FIG. 5, the ceiling assembly 12 is shown in a cross section, and the essential components are formed by the bottom cover panel 13, the top cover panel 15 and the filler 14 arranged between the cover panels 13 and 15. The structural elements 16 represented by way of example pass through the filler 14 in such manner that it is divided into a plurality of components which, however, can also be connected in certain regions. In particular when the filler is introduced between the cover panels 13, 15 in the foaming process, it is advantageous if the structural elements 16 do not completely separate the filler 14 into separate parts, but instead there are connections between skin structures of the filler. The horizontally running structural element 16 can also form a further intermediate cover panel. The functional elements 17 are shown by way of example as a drive, to which the turnstile can be attached in a manner not shown in detail, a controller 20, a sensor device 21, a light device 22 and a loudspeaker device 23. In addition, for example, braking devices and/or blocking devices for braking and for blocking the rotary movement of the turnstile can also be present.

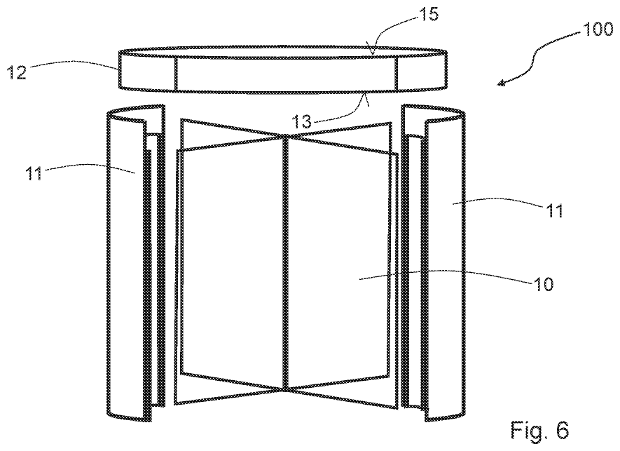

FIG. 6 once again shows the components of the revolving door 100, comprising the turnstile, the barrel walls 11 and the ceiling assembly 12.

These individually illustrated components can be brought to the destination of the revolving door 100 each as structural units which can be handled individually, and the components according to the representation can be assembled with one another in a correspondingly simple manner.

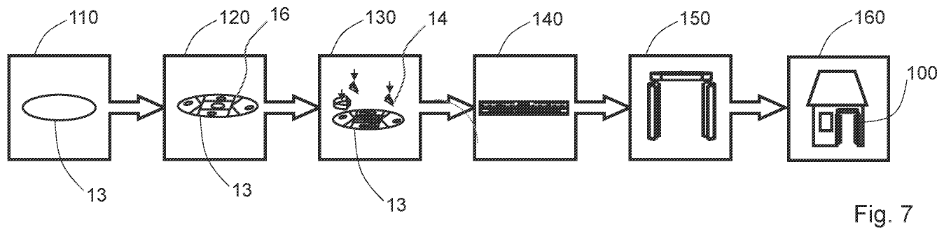

FIG. 7 schematically shows a sequence of the method for producing the ceiling assembly for a revolving door 100, with the method having at least the following steps: First, the bottom cover panel 13 is provided in a preparation step 110. Then, in a configuration step 120, the bottom cover panel is provided with structural elements 16 and/or functional elements 17, which is followed by an introduction step 130, according to which the filler is configured. Thereafter, the sandwich design of the ceiling element is substantially completed in an arrangement step 140 for arranging the top cover panel, whereupon in a finishing step 150, the ceiling assembly is brought to the destination according to the arrangement step 140. In the subsequent assembly step 160, the components of the revolving door 100 are joined together.

1. A revolving door with a turnstile which is arranged between opposing barrel elements and with a ceiling assembly which is arranged on top of the barrel elements and on which the turnstile is rotatably mounted,
wherein the ceiling assembly has a sandwich design with at least one bottom cover panel and/or at least one top cover panel and at least one filler.

2. The revolving door according to claim 1, wherein
the ceiling assembly is configured as an assembly configured to be handled individually and configured to be attached to the barrel elements and/or the turnstile and configured to be detached from the barrel elements and/or the turnstile.

3. The revolving door according to claim 1, wherein
one or a plurality of structural elements and/or functional elements of the revolving door are accommodated at least partially at or over the bottom cover panel and/or at or over the top cover panel, in the region of the filler.

4. The revolving door according to claim 1,
wherein at least the bottom cover panel has one or a plurality of openings such that one or a plurality of structural elements and/or functional elements are arranged in connection with the openings.

5. The revolving door according to claim 1,
wherein
the bottom cover panel and/or the top cover panel are connected to the filler (14) in a materially-bonded and/or force-fitting and/or form-fitting manner.

6. The revolving door according to claim 1,
wherein
the bottom cover panel and/or the top cover panel are connected to one another with the filler in a thermobonding process.

7. The revolving door according to claim 1,
wherein the bottom cover panel and/or the top cover panel have an aluminum material, a steel material and/or a plastic material and/or a glass material and/or in that the filler has a polyurethane material and/or a honeycomb structure.

8. The revolving door according to claim 1,
wherein the structural elements penetrate the filler and/or in that the filler is divided into at least two or a plurality of parts by the structural elements.

9. The revolving door according to claim 1,
wherein the one or the plurality of functional elements comprise at least one drive and/or a controller and/or a sensor device and/or a light device and/or a loudspeaker device and/or a power supply and/or a lock and/or a ventilation device and/or a heating element, wherein the functional elements are arranged in one or a plurality of recesses or intermediate regions in the filler.

10. The revolving door according to claim 1,
wherein the ceiling assembly is arranged on the barrel elements such that the barrel elements laterally enclose the ceiling assembly and/or in that the barrel elements extend up to the height of the top cover panel and/or in that the barrel elements end flush with the top cover panel.

11. A method for producing a ceiling assembly for a revolving door, according to claim 1, wherein the method including at least the following steps:
providing a bottom cover panel and/or providing a top cover panel;
configuring the structural elements and/or functional elements at or on the bottom cover panel and/or at or on the top cover panel;
introducing a filler at the bottom cover panel or at the top cover panel;
connecting in a materially-bonded and/or force-fitting and/or form-fitting manner, the bottom cover panel and/or the top cover panel to the filler.

12. The method according to claim 11,
wherein the filler is arranged in geometrically prefabricated elements in the intermediate regions between the structural elements and/or functional elements (17).

13. The method according to claim 11,
wherein the materially-bonded connection of the bottom cover panel and/or the top cover panel with the filler is produced in a thermobonding process.

14. The method according to claim 11,
wherein the ceiling assembly is designed as an assembly which can be handled individually and is attached to the barrel elements and/or the turnstile, in a reversibly detachable manner.
